(19) United States
(12) Patent Application Publication
(10) Pub. No.: US 2016/0157005 A1
(43) Pub. Date: Jun. 2, 2016

(54) EARPHONE CORD MANAGEMENT STRAP

(71) Applicants: Jared Green, New York, NY (US); William Woodward, New York, NY (US)

(72) Inventors: Jared Green, New York, NY (US); William Woodward, New York, NY (US)

(21) Appl. No.: 14/944,208

(22) Filed: Nov. 17, 2015

Related U.S. Application Data
(63) Continuation of application No. 62/080,992, filed on Nov. 17, 2014.

(51) Int. Cl. H04R 1/10

(52) U.S. Cl. CPC H04R 1/105; H04R 1/1033

(57) ABSTRACT

The invention provides systems, methods, and devices that comfortably secure earphones about a user's neck. The inventive device is a strap worn around a user's neck. The strap has snaps to secure earphone wires, and clips at both ends to secure earphones to a user by securing the earphone cords to a user's neck. The clips comprise channeled jaws coupled via a spring hinge. Further, the snaps when connected secure a wrapped cord to the earphone cord management strap to prevent cord tangling.

### CROSS REFERENCE TO RELATED APPLICATIONS

The invention is related to and claims priority from U.S. Provisional Patent Application No. 62/080,992 entitled EARPHONE CORD MANAGEMENT STRAP WITH CLIPS to common inventor Green filed on Nov. 17, 2014.

### TECHNICAL FIELD OF THE INVENTION

The invention is related to systems, methods, and devices for securely coupling earphones to a user.

### Statement of a Problem Addressed by the Invention

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

Earphone cords often get tangled when stored in pockets, backpacks, and glove compartments. In some instances, untangling the cords may take several minutes to make the earphone ready to use. This doesn't just create an annoyance to untangle and unwind—the twisting often breaks an electrical connection required to send sound to one (or both) of the buds' speakers.

Another problem is that earphone cords can get tugged, snagged or jostled thereby creating stress on the cords and making the earphones fall from a user's ear(s). Accordingly, what are needed are systems, methods, and devices that secure earphones around a user's neck and allow easy and uncluttered storage of earphone cords; the present invention discloses such solutions.

### SUMMARY

Accordingly, it is an object of the present invention to provide systems, methods, and devices that in one configuration comfortably secure earphones proximate to the user's head.

In an embodiment, the device is a strap worn around the back of a user's neck, and that attached to earphone cords. The strap is preferably secured to the earphone cords via cliping members at both ends of the strap. In one embodiment, cliping members comprise a spring hinge, and cord channel for accepting earphone cords in at least one jaw of the cliping member.

In another embodiment of the invention, the earphone cord is prevented from tangling by coiling and securing the earphone cord about attached snaps.

In yet another embodiment, the strap is preferably made of fabric, an elastic material, or a combination of the two. Each ear phone cord is coupled to the strap via a clip at each end of the strap, and then the elastic strap rests about the back of the user's neck.

### BRIEF DESCRIPTION OF THE DRAWINGS

Various aspects of the invention as well as an embodiment are better understood by reference to the following exemplary embodiment. For better understanding of the invention, the exemplary embodiment should be read in conjunction with the drawings, in which:

FIG. 1 shows the invention with its strap resting behind a user's neck, and showing earphone cords resting on his chest.

FIG. 2 shows a close-up of the invention's clips and snaps.

FIG. 3 shows an earphone cord ready to be secured in an inventive clip.

FIG. 4 shows a coiled headphone cord secured by the invention.

### EXEMPLARY EMBODIMENT

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time of patent filing. Since one of ordinary skill in the art may recognize substantially equivalent structures or substantially equivalent acts to achieve the same results in exactly the same way in light of the following exemplary embodiment, or to achieve the same results in a not dissimilar way; the following exemplary embodiment should not be interpreted as limiting the invention to one embodiment.

Likewise, individual aspects (sometimes-called species) of the invention are provided as examples. Accordingly, one of ordinary skill in the art may recognize from a following exemplary structure (or a following exemplary act) a substantially equivalent structure or substantially equivalent act to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated. (For example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

As will be understood by those of ordinary skill in the art, various structures and devices are depicted in block diagram form in order to avoid unnecessarily obscuring the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### DESCRIPTION OF THE DRAWINGS

Earphones, such as earbuds, or in-ear/on-ear headphones, and the like, are widely used to listen to audio, such as recorded music, audio books, or dispatcher instructions. Predictably, earphones are widely employed while jogging or performing manual tasks.

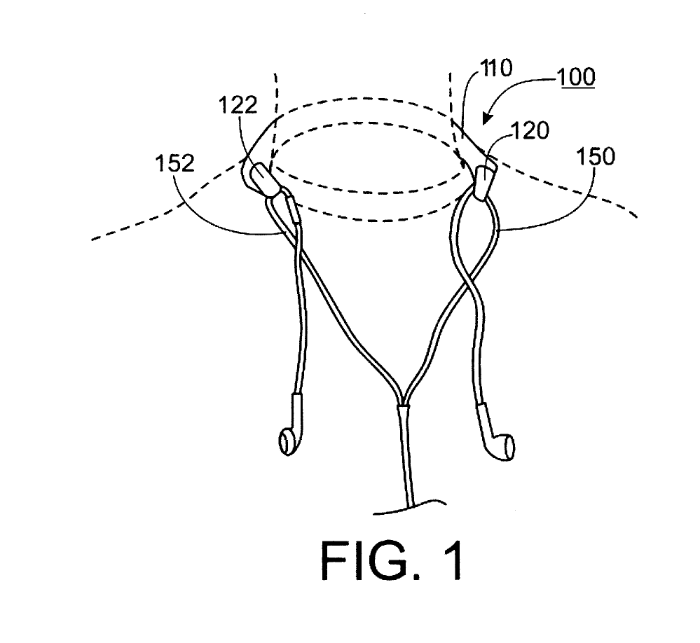

FIG. 1 shows the invention, the earphone cord management strap 100, with its strap portion 110 resting behind a user's neck, and also shows earphone cords 150, 152 attached to the earphone cord management strap 100 and resting on the user's chest. The strap portion 110 is coupled to the cords 150, 152 via clips 120, 122. It is appreciated that clips may also ordinarily be called clamps or clasps, and such naming conventions are not limiting so long as the functionality of the device is substantially similar to that of the clips disclosed herein. Preferably, the strap portion 110 provides a surface area for a logo, image, or wording, and is preferably made of plastic, fabric, elastic or a combination thereof.

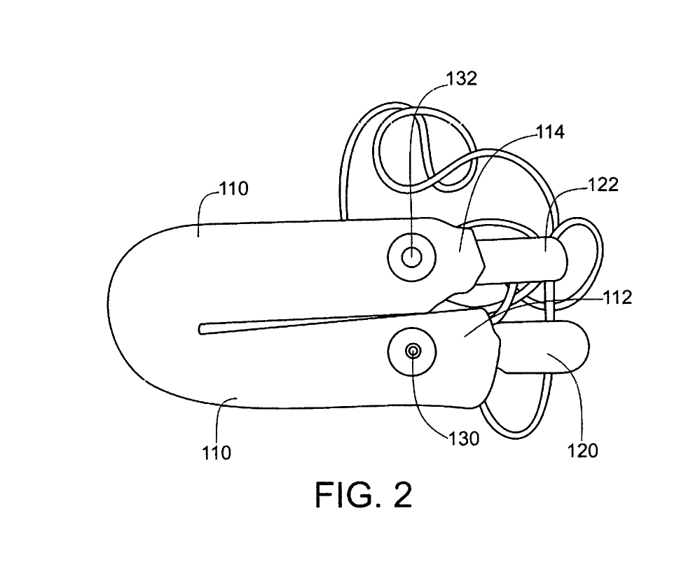

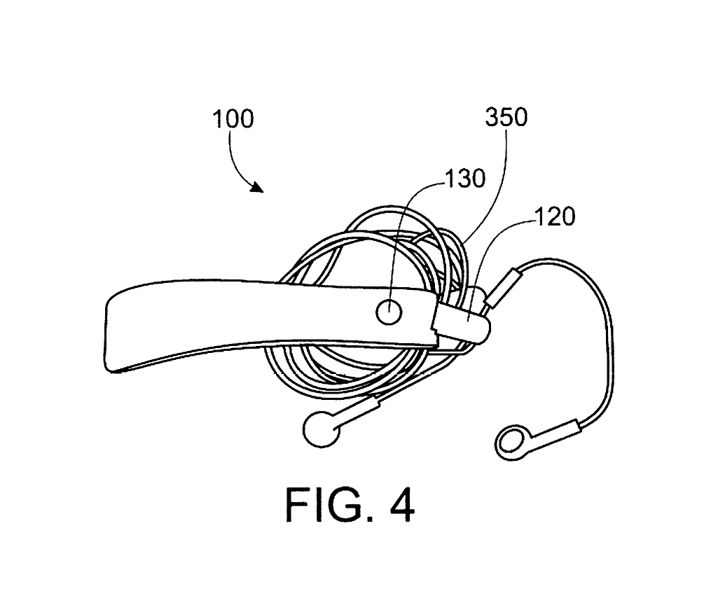

FIG. 2 shows a close-up of the invention's clips 120, 122 and snaps 130, 132 which are attached to the strap portion 110. As is shown in FIG. 2, a first clip 120 is attached to a first end 112 of the strap portion 110, and a second clip 122 is coupled to a second end 114 of the strap portion. The snaps 130, 132 are coupled to the strap portion 110 a sufficient distance from the first end 112 and the second end 114 so that when the snaps are connected a plurality of cords, such as a lariat of cords, are securable by the strap portion 110 to prevent tangling as is discussed below in FIG. 4.

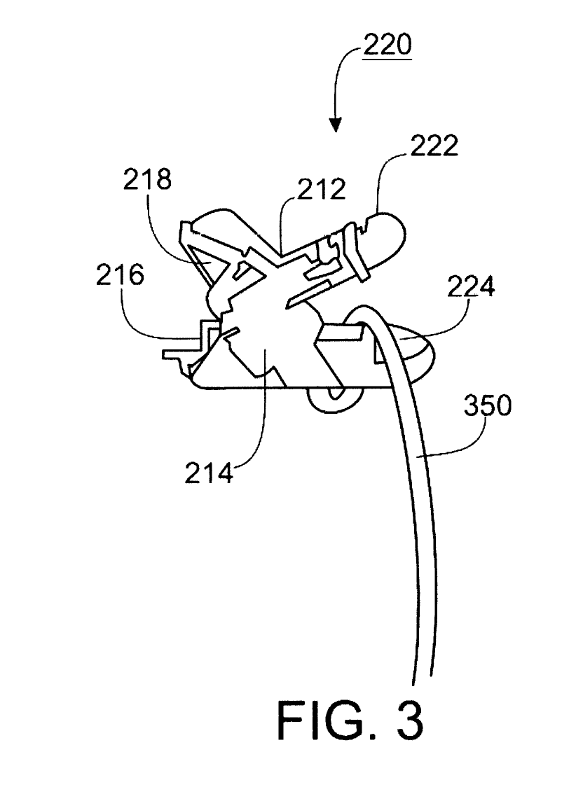

FIG. 3 shows an earphone cord 350 ready to be secured in the first clip 220. The first clip 220 includes a first jaw 212 coupled to a second jaw 214 through a clip hinge 216. At least the first jaw 212 includes a first lever portion 218 (aka “fulcrum”) to facilitate the opening of the first clip 220. Additionally, the clip hinge 216 comprises an axel integrated into the first jaw 212 and hinge hole integrated into the second jaw 214. The first jaw 212 and the second jaw 214 are articulated by a spring 216 coupled between the jaws 212, 214, as is understood by those of ordinary skill in the mechanical arts.

In addition, the first jaw 212 includes a first cord channel 222, and the second jaw 214 includes a second cord channel 224. The cord channels 222, 224 allow the earphone cord 350 to be secured between closed jaws 212, 214. Of course, a cord channel can be created using two cord channel portions (one in the interior of each jaw), or a cord channel may exist in one jaw interior only, although ultimately a cord channel is defined by, when the jaws 212, 214 are closed on each other, a single channel that is substantially shaped to secure an earphone cord. As shown, each cord channel 222, 224 traverses each jaw 212, 214 substantially perpendicular to each jaw's length. Similarly, a plurality of cord channels of various sizes may be included in either or both jaws to accommodate cords of various shapes, sizes, or gauges. Furthermore, while a spring is shown, alternative components for articulating the jaws 212, 214 are known and may be used instead of the spring.

FIG. 4 shows a coiled headphone cord 350 secured by the earphone cord management strap 100. Here, the snap 130, 132 at each strap end 112, 114 is provided to hold the coiled earphone cord 350 during storage and/or transport. When the snaps 130, 132 are coupled together as shown in FIG. 4, the coiled cord 350 is secured in the shape of a lariat. In this configuration, the strap portion 110 may be hung on a hook, if so desired.

In operation, a user opens each clip and places one earphone cord into the first clip and the other cord into the second clip, preferably at about six inches away from each earphone, and each clip is closed. A closed clip secures its cord, and may in one embodiment may be separately “locked” into a closed position.

While the clips and strap are in place, the user may remove the earphones from his ears and let the earphones hang from the strap portion. Accordingly, the jostling of a cords, and the snagging or tugging of an earphone cord, the strap takes the stress (instead of the earphones), preventing the earphones from falling from the user's ear(s).

The clips make it possible to adjust the placement of the clips on an earphone cord. An additional benefit of the clips is that they make it easy to remove one earphone cord management strap and replace it with another strap having a different design.

Although the invention has been described in terms of a specific preferred embodiment, many advantages, variations, and modifications will be apparent to those skilled in the art upon reading the present application. It is therefore the intention that the appended claims and their functional equivalents be interpreted as broadly as possible in view of the prior art to include all such variations and modifications.

What is claimed is:

1. An earphone cord management strap with clips, comprising:
a fabric-like strap being of an unstretched length of between four and twenty inches, and having a first end and a second end, the first end having a first snap and the second end having a second snap;
a first clip coupled to the first strap end;
a second clip coupled to the second strap end; and
each clip having a first jaw and a second jaw coupled to each other via an articulatable spring-loaded hinge, and a spring coupled between the first jaw and the second jaw, and wherein at least one jaw comprises a channel for accepting an earphone cord.

2. The apparatus of claim 1 wherein each snap is riveted to each end of the strap.

3. The apparatus of claim 1 further comprising a first earphone cord coupled to the first clip, and a second earphone cord coupled to the second clip, the first earphone cord and the second earphone cord being couplable to an earphone jack.

4. The apparatus of claim 1 wherein the strap is elastic.

5. The apparatus of claim 2 wherein the first snap is located sufficiently far from the first end, and the second snap mechanism is located sufficiently far from the second end to, when snapped together, define a gap that is sized to accommodate a lariat of earphone cording.
